(19) United States
(12) Patent Application Publication
(10) Pub. No.: US 2026/0119895 A1
(43) Pub. Date: Apr. 30, 2026

(54) GENERATING MODIFIED PROMPTS BASED ON FEEDBACK

(71) Applicant: Microsoft Technology Licensing, LLC, Redmond, WA (US)

(72) Inventors: Lindsay Gray GREENE, Seattle, WA (US); Harry Leo EMIL, Redmond, WA (US); Danielle Simone JONES, Brooklyn, NY (US); Erik Vernon DAY, Bellevue, WA (US); Subramanian VUTTRAVADIUM VENKATA, Redmond, WA (US); Andrew Paul MCGOVERN, Kirkland, WA (US); Rashmi PARTHASARATHY, Sammamish, WA (US); Aaron Joshua SANCHEZ, Seattle, WA (US); Arshdeep SEKHON, Fort Mill, SC (US); Tianwei CHEN, Waltham, MA (US); Kunal PATIL, Lynnwood, WA (US); Molly Rose CORNNELL, Woodinville, WA (US); Jessica Anne BOURGADE, Seattle, WA (US); Olivier Michel Nicolas GAUTHIER, Duvall, WA (US); Soundararajan SRINIVASAN, Cambridge, MA (US); Irene Rogan SHAFFER, Cambridge, MA (US); Zhuoyi HUANG, Palo Alto, CA (US); Diana LICON, El Paso, TX (US); Julian Vincent Paul EIGEMANN, Bellevue, WA (US); Chunlei WU, Beijing (CN); Qianlan YING, Beijing (CN)

(21) Appl. No.: 18/930,735

(22) Filed: Oct. 29, 2024

(51) Int. Cl. G06N 3/091; G06F 3/04817; G06N 3/045; G06N 3/0475

(52) U.S. Cl. CPC G06N 3/091; G06N 3/045; G06N 3/0475; G06F 3/04817

(57) ABSTRACT

The present disclosure relates generally to systems and methods for updating an input prompt for a generative AI model (e.g., an LLM) based on feedback that is provided in connection with an output from the generative AI model that is unsatisfactory. For example, where a user indicated that an output from the generative AI model is incorrect, inaccurate, or is an otherwise unsatisfactory response to an input prompt, this disclosure describes models to facilitate generation of feedback hints and/or additional information that can be included within an updated prompt that, when provided as an input to the generative AI model, has an improved likelihood to return an output that is in-line with user expectations. Indeed, features of the systems and methods described herein provide a framework for improving outputs of generative AI models that are more accurate or otherwise responsive to the input prompts.

### BACKGROUND

Large language models (LLMs) and other generative artificial intelligence (AI) models have demonstrated strong reasoning abilities, enabling them to plan and interact with a large corpus of tools and applications. This has led to the development of LLM-based agents to enhance the capabilities of LLMs and other models and have become an increasingly common tool for task delegation, assisting with a wide range of requests by generating responses, interacting with user proxies, and producing final action plans. For example, LLMs (and other generative AI models) and LLM-based agents are currently employed to perform a wide variety of tasks, such as providing responses to various queries and prompts.

While generative AI models provide helpful tools in processing various tasks, generative AI models suffer from a number of problems and drawbacks. For example, while generative AI models have capability to understand a wide variety of contexts, various models will often generate outputs that are inaccurate or otherwise non-responsive to an input prompt. In the event that a response to a prompt is non-responsive, inaccurate, or otherwise unsatisfactory to an end-user, this can cause frustration and ultimately lead to individuals abandoning use of generative AI models to perform tasks notwithstanding those models having the functionality to perform the tasks.

Indeed, in many scenarios, a generative AI model may be capable of performing a given task where the prompt is crafted in a way that effectively communicates the task to the generative AI model and in a manner that enables the model to accurately interpret and carry out the task. Crafting effective prompts, however, often requires significant experience and/or knowledge of how a generative AI model processes various inputs and tasks. In attempting to improve generative AI model accuracy, conventional organizations will receive feedback and task a team of individuals to further train or configure the various models to more accurately process certain types of input. While these teams of experts are gradually improving the way that generative AI models operate, it is often transparent to an end-user whether the generative AI model(s) are improving. Moreover, any improvements to the generative AI models are often not realized for the individual that is providing the input and requesting the AI model(s) to perform various tasks.

These and other limitations exist in connection with using generative AI models to perform various tasks as well as collecting and implementing user feedback to improve operation of the generative AI models.

### BRIEF DESCRIPTION OF THE DRAWINGS

FIG. 1 illustrates an example environment in which an AI model feedback system is implemented on a server in accordance with one or more embodiments.

FIG. 2 illustrates example interactions between components of the AI model feedback system in accordance with one or more embodiments.

FIGS. 3A-3C illustrate an example workflow in which the AI model feedback system receives feedback and generates an updated prompt in accordance with one or more embodiments.

FIGS. 4A-4D illustrate another example workflow in which the AI model feedback system receives feedback and generates an updated prompt in accordance with one or more embodiments.

FIG. 5 illustrates an example series of acts for determining whether received feedback is actionable in connection with generating an updated prompt in accordance with one or more embodiments.

FIG. 6 illustrates an example series of acts for generating and implementing feedback in modifying prompts for a generative AI model in accordance with one or more embodiments.

FIG. 7 illustrates certain components that may be included within a computer system.

### DETAILED DESCRIPTION

The present disclosure relates to systems, methods, and computer-readable media for updating an input prompt for a generative AI model (e.g., a general-purpose generative AI model or large language model (LLM)) based on feedback that is provided in connection with an output from the generative AI model that is unsatisfactory. Indeed, where a user indicates that an output from the generative AI model is incorrect, inaccurate, or is an otherwise unsatisfactory response to an input prompt, systems described herein facilitate generation of feedback hints and/or additional information that can be included within an updated prompt that, when provided as an input to the generative AI model, has a better chance at returning an output that is in-line with end-user expectations and which generally provides an improved output that is more accurate or otherwise responsive to the input prompt(s).

As an illustrative example, systems (and/or methods and computer readable media) described herein involve generating a feedback request in connection with an output of a generative AI model, the output being generated in response to an initial prompt (e.g., a previous prompt). The systems described herein perform an actionability check on the response to the feedback request to determine that a modified prompt having additional item(s) of information would be actionable by the generative AI model. The systems may further generate a feedback icon including an interactive element enabling a user to indicate the additional item(s) of information to include within the modified prompt. The system may further generate the modified prompt based on a combination of the initial prompt and the additional item(s) of information generated from the feedback response(s). The system may finally apply the generative AI model to the modified prompt to generate an updated output that is more responsive or otherwise satisfactory to the user who provided the initial prompt to the generative AI model.

The present disclosure provides a number of practical applications that provide benefits and/or solve problems associated with receiving and implementing feedback associated with processing prompts to a generative AI model. By way of example and not limitation, some of these benefits will be discussed in further detail below.

For example, as will be discussed herein, an AI model feedback system provides a workflow in which feedback about a model output is received, processed, and implemented within a single session between a user and a client of the generative AI model. This workflow within a single session enables a user to see immediate results of provided feedback, which inspires trust in the generative AI model(s) while encouraging the user to continue using the product. In addition, this provides a real-time representation of the improvement between subsequent outputs from the generative AI model(s). This informs the user as to why a subsequent output is an improvement over a previous output, resulting in a gradual improvement of prompts generated and provided as inputs to the generative AI model within the same and future sessions.

As will be discussed herein, by evaluating and verifying feedback (e.g., determining actionability) that is received in connection with a failed (or otherwise unsatisfactory) prompt, the AI model feedback system can determine whether feedback is actionable prior to modifying the prompt and/or feeding an updated prompt into the generative AI model. This determination of actionability prevents unnecessary back and forth with a generative AI model, which results in fewer queries or tasks that are processed using a robust and computationally expensive generative AI model. This decreases the number of computational resources that are expended when using a generative AI model, providing scalability and resource management benefits to a computing device or computing environment (e.g., a cloud computing system) on which the generative AI model is implemented.

Indeed, as will be discussed below, the AI model feedback system performs a multi-stage process in which feedback is provided to a separate model (e.g., a feedback model) to accurately determine or otherwise predict actionability or, in the event that the feedback may be actionable, directing the user to provide additional information to make the feedback actionable. This multistage process further decreases the computational load on the generative AI model, thereby improving the efficiency with which often limited processing resources are expended by the generative AI model.

In one or more embodiments, the AI model feedback system provides feedback icons to assist a user in providing feedback that is actionable. By providing feedback icons including hints and/or selectable icons of additional information items, the AI model feedback system leverages knowledge of the specific configuration of the generative AI model to prompt a user to provide relevant information that has a higher likelihood of prompting the generative AI model to provide meaningful outputs and/or more accurately perform a variety of tasks. Indeed, by providing these icons, the AI model feedback system enables a user who is not otherwise familiar with the configuration or programming or training of the generative AI model to provide relevant and actionable feedback that can be used to improve upon the operation of the generative AI model in a meaningful way. Further, this “training” of a user to provide specific types of information will likely improve operation of the generative AI model with respect to the user over time as a user becomes more knowledgeable of the type of information that should be included within prompts that are input to a generative AI model.

As illustrated in the foregoing discussion, the present disclosure utilizes a variety of terms to describe features and advantages of one or more embodiments of an AI model feedback system described herein. Additional detail will now be provided regarding the meaning of some of these terms.

As used herein, the term “generative artificial intelligence (AI) model” or simply “generative AI model” refers to a computational system that utilizes deep learning and a large number of parameters (e.g., billions or trillions for a large version and fewer for a small version) and trained on one or more extensive datasets to produce coherent, contextually relevant, and fluent outputs (e.g., text and/or images) specific to a particular topic. In many cases, a generative AI model is an advanced computational system that uses natural language processing, machine learning, and/or image processing to generate human-like responses that are coherent and contextually relevant. For instance, generative AI models can create outputs in various formats, including one-word answers, long narratives, images, videos, labeled datasets, documents, tables, and presentations. In one or more embodiments, an output refers to a task (e.g., a single or multi-step task) that the generative AI model performs in response to an input.

Moreover, generative AI models are primarily based on transformer architectures for understanding, generating, and manipulating human language. Generative AI models can also utilize other types of architectures such as recurrent neural network (RNN) architecture, long short-term memory (LSTM) model architecture, convolutional neural network (CNN) architecture, or other types of architectures. Examples of generative AI models include generative pre-trained transformer (GPT) models like GPT-3.5, GPT-4, and GPT-4o, bidirectional encoder representations from transformers (BERT) models, text-to-text transfer transformer models like T5, conditional transformer language (CTRL) models, and Turing-NLG. Other types of generative AI models include sequence-to-sequence models (Seq2Seq), vanilla RNNs, and LSTM networks.

In some instances, a generative AI model includes a large language model (LLM), a small language model (SLM), a large action model (LAM), and a small action model (SAM), which serve as text-based versions of a generative AI model, such as those that receive text prompts and/or generate text outputs. In various implementations, a generative AI model is a multimodal generative model that receives multiple input formats (e.g., text, images, video, data structures) and/or generates multiple output formats. In one or more embodiments described herein, the AI model feedback system utilizes one or multiple LLMs to generate outputs based on input prompts.

In one or more embodiments described herein, a prompt or input prompt is provided as an input to a generative AI model. As used herein, a “prompt” refers to an input or query that is provided to guide or otherwise direct a generative AI model's response. A prompt may include a question, statement, or any form of text that is provided as an input to the generative AI model with an expected output. In one or more embodiments, a prompt includes associated context, preferences, and any other parameters that further guides the generative AI model in generating an output.

As will be discussed herein, an output of the generative AI model may be designated as satisfactory or unsatisfactory. As used herein, an “unsatisfactory output” or an output designated as unsatisfactory may simply refer to an output for which a user input has been received indicating that the output is an unsatisfactory output and/or that the output does not align with an expectation of a user with respect to the prompt that was provided as input to the generative AI model.

In one or more embodiments described herein, a prompt may be referred to as an “initial prompt” and a “modified prompt” or “updated prompt”. As used herein, an “initial prompt” refers to any previous prompt prior to generating a modified or updated prompt to provide as input to a generative AI model. In one or more embodiments, the initial prompt refers to a first prompt that is submitted via a prompt interface. In one or more embodiments, the initial prompt refers to any prompt that is indicated as unsatisfactory and for which feedback data is collected or otherwise obtained. As used herein, a “modified prompt” or “updated prompt” refers to any prompt subsequent to an initial prompt that has been updated or modified based on feedback data that is received in connection with the initial prompt (or output to the initial prompt).

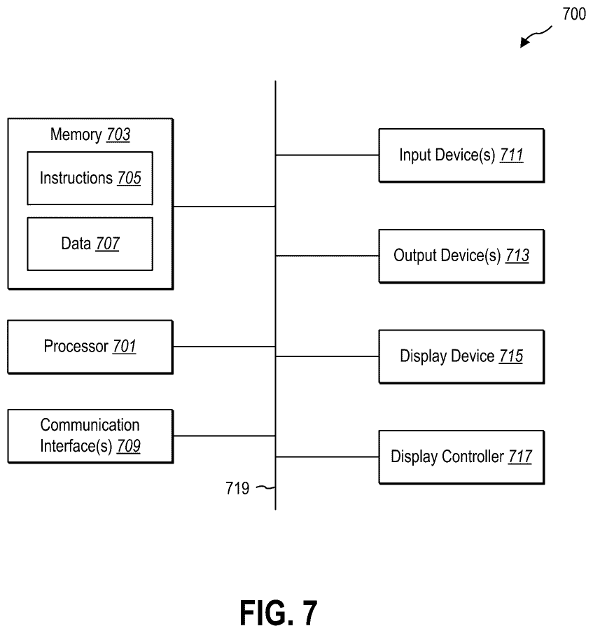

As used herein, a client or client device may refer to any type of electronic device or client application capable of sending and receiving data over a network. In one or more embodiments, the client or client device refers specifically to a mobile device such as a mobile telephone, a smart phone, a personal digital assistant (PDA), a tablet, a laptop, or a wearable computing device. In one or more embodiments described herein, a client or client device refers to a mobile device having a touch screen interface whereupon selectable icons can be presented and selected by a user of the client device. Indeed, as will be discussed in connection with one or more embodiments described herein, a client or client device may provide an interface through which a user may interact with a generative AI model, both in providing inputs (e.g., prompts) and feedback to the AI model feedback system as well as receiving outputs that the user may review in determining whether the output is satisfactory and/or whether specific feedback should be provided to the AI model feedback system. Additional detail in connection with an example computing device that may refer to an example client or client device is discussed below in connection with FIG. 7.

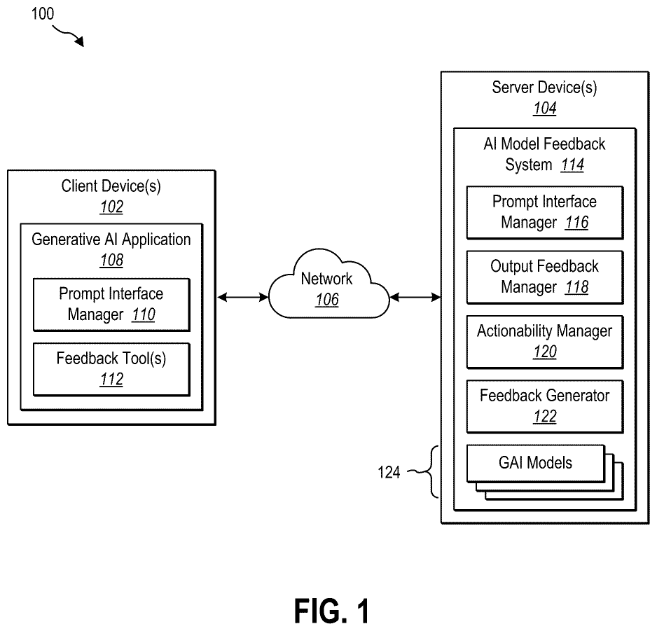

Additional details regarding example implementations of the AI model feedback system will now be discussed in connection with one or more example implementations shown in the figures. For example, FIG. 1 illustrates an environment 100 including a client device(s) 102 in communication with a server device(s) 104 via a network 106. As noted above, the client device(s) 102 may refer to a physical client device, such as a laptop, mobile device, or other user electronic device. Alternatively, the client device(s) 102 may refer to a remote device, such as a server or computing device that is hosted by a cloud computing system. Similarly, the server device(s) 104 may refer to server node or other computing device that is hosted on a cloud computing system and which includes or otherwise provides access to one or more generative AI models. Finally, the network 106 may refer to one or multiple networks and may use any communication platforms or technologies suitable for transmitting data. Indeed, the network 106 may refer to any data link that enables the transport of electronic data between devices and/or modules of the environment 100. In one or more embodiments, the network 106 includes the Internet.

As shown in FIG. 1, the client device(s) 102 includes a generative AI application 108 thereon. The generative AI application 108 may provide any client-facing functionality of an AI model feedback system, as discussed in further detail below. In one or more embodiments, the generative AI application 108 refers to a software application or a web application that provides the client-facing functionality of one or more embodiments described herein. As shown in FIG. 1, the generative AI application 108 includes a prompt interface 110 and one or more feedback tool(s) 112.

The prompt interface 110 provides a user interface through which a user of the client device 102 may interact to provide prompts, feedback, or otherwise provide data to the AI model feedback system. In one or more embodiments, the prompt interface 110 refers to a web browser or software program interface through which a user may compose a prompt and submit the prompt as feedback to a generative AI model. In one or more embodiments, the prompt interface 110 enables a user to modify a prompt, provide follow up prompts, indicate user preferences, or provide any user-composed or user-selected information that may be used in performing various tasks and providing outputs of the generative AI model(s).

The feedback tool(s) 112 may refer to any of a variety of applications, programs, or software tools that enable an individual to provide feedback with respect to an output from a generative AI model. The feedback tool(s) 112 may provide a feedback request that enables a user to indicate that an output is unsatisfactory. The feedback tool(s) 112 may also include icons or interfaces that enable a user to provide more information indicating why an output is unsatisfactory that may be used by components of the AI model feedback system to generate a modified prompt. The feedback tool(s) 112 may be used to enable a user to select, indicate, or otherwise provide additional items of information that may be used in generating further feedback and/or revising a prompt that will likely yield a more satisfactory output. Examples of some of these feedback tool(s) 112 will be discussed in further detail below.

As shown in FIG. 1, the server device(s) 104 includes an AI model feedback system 114. As further shown, the AI model feedback system 114 includes a prompt interface manager 116. The prompt interface manager 116 manages display of a prompt and/or output of the generative AI model to the user of the client device 102. In one or more embodiments, the prompt interface manager 116 facilitates display of an interface that enables a user to compose and provide an initial prompt. The prompt interface manager 116 may additionally provide an icon or feedback request that enables a user to indicate that an output in response to the initial prompt is unsatisfactory. Indeed, the prompt interface manager 116 may facilitate any features and functionality related to providing a display of an interface that enables a user to interact with icons, compose text, or otherwise interact with a prompt interface and/or feedback tools that are presented via a graphical user interface (GUI) of the client device(s) 102.

As shown in FIG. 1, the AI model feedback system 114 additionally includes an output feedback manager 118. The output feedback manager 118 facilitates collection of feedback indicating that an output responsive to a prompt (e.g., an initial prompt) is unsatisfactory. In one or more embodiments, the output feedback manager 118 collects feedback by providing a selectable icon (e.g., a thumbs down icon, a down arrow icon) that a user may select to indicate that an output is incorrect, inaccurate, or otherwise unsatisfactory. In addition, in one or more embodiments, the output feedback manager 118 provides a field (e.g., a text field) that enables a user to compose a reason or explanation as to why the output is unsatisfactory. In one or more embodiments, the output feedback manager 118 collects these reasons for the sub-optimal output by way of selectable icons. In one or more embodiments, the output feedback manager 118 enables a user to compose text-based feedback indicating reasons why the output is not acceptable.

As further shown, the AI model feedback system 114 includes an actionability manager 120. The actionability manager 120 may perform an analysis of the initial feedback and the prompt to determine whether the received feedback (e.g., a response to a feedback request) provides enough information as well as relevant information that the feedback is actionable. In one or more embodiments, the actionability manager 120 determines whether the feedback provided by the user indicates one or more items of information that would be actionable by the generative AI model. In one or more embodiments, this analysis involves determining whether the item(s) of information, if included or otherwise incorporated into a modified prompt, would cause the generative AI model to generate an output that is satisfactory (or, in the least, more satisfactory than the output generated in response to the initial prompt).

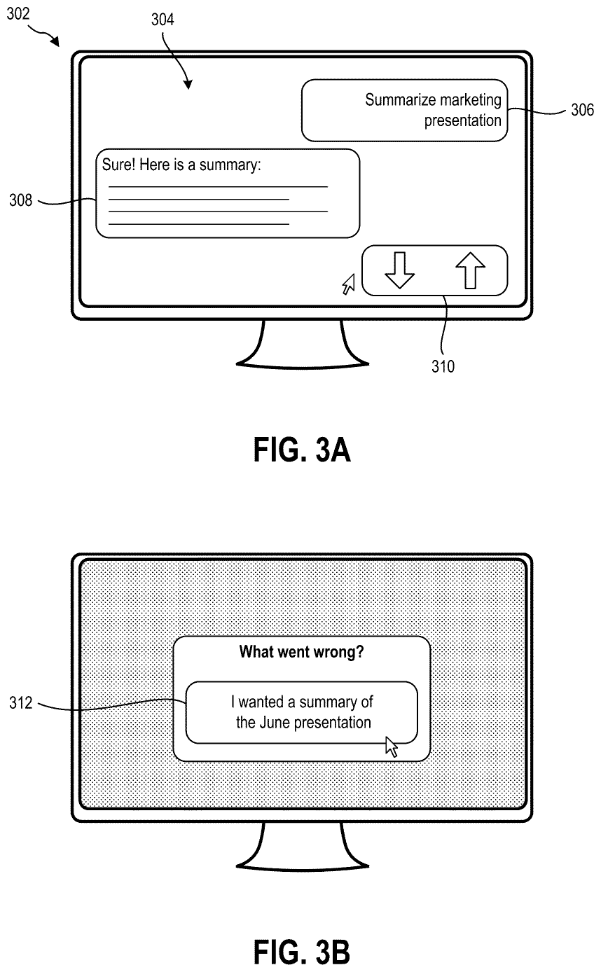

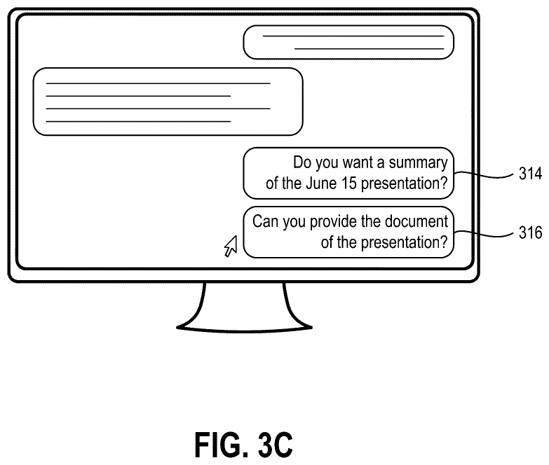

Determining actionability may involve a multi-step process in which a feedback model determines actionability based on any number of factors. In one or more embodiments, the actionability manager 120 determines whether one or more predetermined scenarios exist (e.g., false negative scenarios) that are associated with actionability of the feedback model. In one or more embodiments, the actionability manager 120 further determines if items of information are included within the feedback that would render the feedback actionable. In one or more embodiments, the actionability manager 120 determines whether additional information is needed that would likely make the feedback actionable. The actionability manager 120 may facilitate collection of this additional feedback data in a number of ways. Additional information in connection with these and other examples will be discussed in further detail below (e.g., in connection with FIGS. 3A-5).

As shown in FIG. 1, the AI model feedback system 114 further includes a feedback generator 122. After determining that the feedback (by itself or in combination with the initial prompt) is actionable, the feedback generator 122 may generate additional information to incorporate in a modified prompt. In one or more embodiments, the feedback generator 122 provides selectable elements via a GUI that a user may select to indicate one or more additional items of information that would make the modified prompt more suitable to produce a satisfactory output from the generative AI model. In one or more embodiments, the feedback generator 122 provides feedback hints to guide a use in providing relevant information that, if incorporated with content from the initial prompt, would result in a modified prompt that would similarly yield more satisfactory results than the initial prompt. Additional detail in connection with generating or otherwise obtaining the additional information based on feedback and an initial prompt will be discussed in further detail below.

As shown in FIG. 1, the AI model feedback system 114 may make use of a number of generative AI models 124 (GAI models 124) to perform features and functionalities of the AI model feedback system 114 as discussed herein. In one or more embodiments, the AI model feedback system 114 uses a first GAI model, which refers to a first generative AI model (e.g., a user-facing generative AI model) that receives the initial and modified prompts in generating respective outputs. In one or more embodiments, the AI model feedback system 114 uses a second GAI model, referring to an actionability model that determines actionability of the feedback data received based on an unsatisfactory output responsive to the initial prompt. In one or more embodiments, the AI model feedback system 114 uses a third GAI model, or feedback model, to generate feedback chips or hints that may be presented via a GUI of the client device 102 to guide a user in providing additional information that may be incorporated within the modified prompt.

It will be appreciated that the plurality of GAI models 124 may refer to different types of models capable of performing respective tasks of the AI model feedback system 114 described herein. In one or more embodiments, the GAI models 124 refer to LLMs that are capable of analyzing language and generated a wide variety of outputs. While one or more embodiments describe the workflow as including three distinct GAI models, one or more embodiments may combine or separate features and functionalities of the respective models described herein. As an example, where a first generative AI model may refer to a user-facing generative AI model and be tasked with processing prompts and generating outputs based on the variable user-generated prompts, additional one or more GAI models may be used in determining actionability and generating additional feedback or information that may be used to augment an initial prompt. In contrast to the first generative AI model, these additional GAI models may be back-end models that are not necessarily user-facing, but which are specifically tasked with determining actionability and/or generating feedback that are presented to a user via an interface of the first GAI model.

Moreover, in one or more embodiments, the GAI models 124 may be in communication with or incorporated as tools that may be operated in combination with one another. For example, the actionability check and the feedback generation may be combined within an interface presented to a user and, in some instances, presented as tools that are incorporated within a generative AI interface tool. Examples of how this may be performed and/or presented will be discussed in further detail below.

As noted above while the environment 100 shows two devices in communication with one another, this is provided as an example implementation that is not intended to be limiting to two devices. Indeed, one or more features described in connection with the components of the AI model feedback system 114 may be performed on the client device(s) 102 or on separate server devices from the server device 104 shown in FIG. 1. As another example, one or more of the GAI models 124 may be implemented on separate server devices. In one or more embodiments, the server device(s) 104 and any additional devices of the environment 100 may be implemented on a cloud computing system, with each of the features and functionalities being provided as distinct or combined services on the cloud.

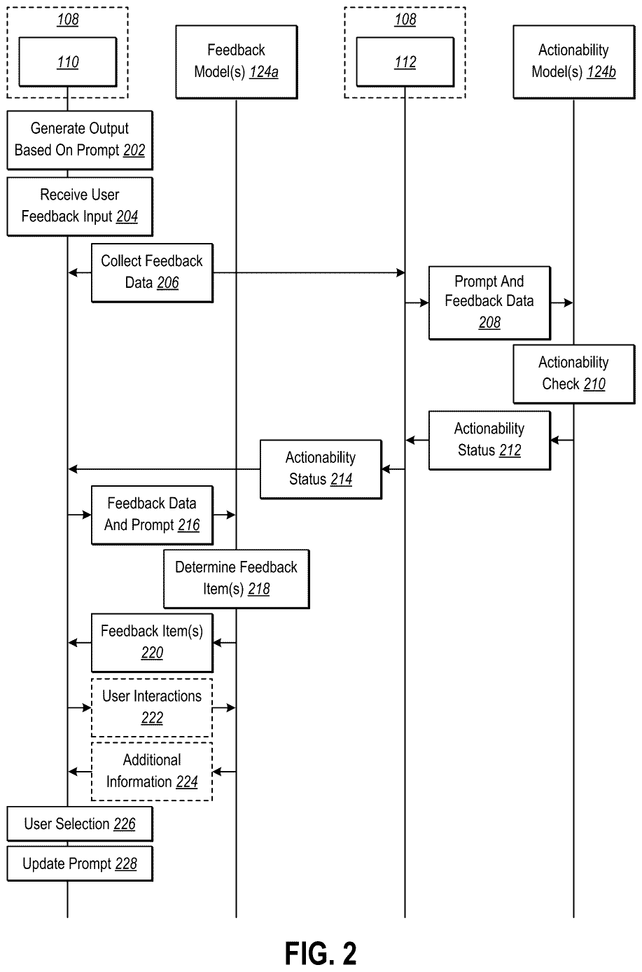

Moving on, FIG. 2 provides an example implementation of the AI model feedback system 114 in which feedback data is gathered and used to generate a modified prompt to be provided as an input to a generative AI model. This example will be discussed in connection with the prompt interface 110 and feedback tools 112 implemented as part of the generative AI application 108, and may be interpreted as being performed in connection with a generative AI model. Thus, while one or more embodiments may describe a generative AI application 108 as performing one or more of the acts shown herein, this may be considered as either the client device 102 performing the respective acts or, alternatively, as a generative AI model being used to perform the respective acts. Moreover, generating feedback and performing actionability checks will be discussed in connection with feedback model(s) 124a and actionability model(s) 124b, which may refer to example GAI models as discussed above in FIG. 1.

As shown in FIG. 2, the generative AI application 108 may perform an act 202 of generating output based on a prompt. In this example, the prompt may refer to an initial prompt provided as an input to the generative AI model. As noted above, this generative AI model may refer to an LLM. In one or more embodiments, the initial prompt is provided as part of a first session. As used herein, a “session” refers to a period of indeterminate time in which a series of prompts may be provided as inputs to a generative AI model. In a typical session, the generative AI model(s) considers previous prompts within the same session to build additional context and further inform the generative AI model on context or information that can be considered in generating subsequent outputs. In one or more embodiments, a session has a capped number of prompts and corresponding outputs that may be generated. In one or more embodiments, a session has a capped number of tokens or other processing units that may be used by the generative AI model. In one or more embodiments described herein, an initial prompt and a modified prompt are provided as inputs to the generative AI model as part of the same session (e.g., the first session, in this example).

As further shown in FIG. 2, the generative AI application 108 may perform an act 204 of receiving user feedback input. In one or more embodiments, the generative AI application 108 provides a feedback icon, such as a selectable graphic that a user may select to indicate satisfaction or dissatisfaction with a particular output (e.g., a response to an initial prompt). In one or more embodiments described herein, the generative AI application 108 receives a user input indicating negative feedback, or that the output is inaccurate, non-responsive, or is an otherwise unsatisfactory response to the initial prompt.

As shown in FIG. 2, the generative AI application 108 may additionally perform an act 206 of collecting feedback data. In one or more embodiments, collecting the feedback data involves providing an interface tool that enables a user to enter feedback data associated with why the output from the generative AI model is unsatisfactory. Various examples in which this feedback data is collected will be discussed in further detail below. As shown in FIG. 2, in one or more embodiments, the feedback tool(s) 112 may collect the feedback data from the prompt interface 110.

As shown in FIG. 2, the generative AI application 108 may perform an act 208 of providing the prompt (e.g., the initial prompt) and the feedback data to the actionability model(s) 124b. In one or more embodiments, this involves providing the prompt and feedback data as inputs to a model (e.g., a GAI model or LLM) configured to determine whether the combination of the prompt and feedback data would be actionable by the generative AI model that processed the initial prompt.

As shown in FIG. 210, the actionability model(s) 124b may perform an act 210 of an actionability check in which the actionability model(s) 124b determines whether the combination of the prompt and feedback data is actionable. In one or more embodiments, this involves determining one or more additional items of information that, if incorporated into the modified prompt, would provide the improved output relative to the output generated by the generative AI model in response to the initial prompt. This is an example where the actionability model(s) 124b determines that the feedback data is indeed actionable.

In another example, the actionability model(s) 124b may determine that the combination of the feedback data and the prompt might be actionable. For instance, this may involve determining that the combination of the initial prompt and the feedback response might include the one or more additional items of information given additional user feedback.

Finally, in one or more embodiments, the actionability model(s) 124b may determine that the feedback is not actionable. This may be based on a determination that the feedback does not indicate any of a plurality of predetermined false negative scenarios. In addition, or as an alternative, this may involve determining that the generative AI model is incapable of generating an improved output based on the feedback and that the feedback model(s) 124a would not have sufficient information to generate feedback hints or have the capability to determine one or more feedback icons that would guide a user to provide additional feedback data.

As noted above, it will be appreciated that the actionability model(s) 124b may refer to an LLM or other generative AI model that is specifically tasked with determining actionability of feedback data. Indeed, in one or more embodiments, the actionability model(s) 124b has a well-trained infrastructure that is specifically trained or otherwise configured to determine actionability of feedback data and does not have the same general or broad capabilities of the user-facing generative AI model that receives the prompts and the verbatims (e.g., the responses to the feedback request). By using an actionability model that is specifically trained to do a targeted task such as determining actionability, this can reduce a computational burden on the infrastructure of the systems, and enables the actionability model to be incorporated as a tool (e.g., one of the feedback tool(s) 112) that operates in conjunction with the user-facing generative AI model. This targeted simple functionality of the actionability model additionally allows the actionability model to be interchangeable with different LLMs or a variety of generative AI models. Moreover, this configuration of models facilitates features and functionalities described herein using smaller and/or simpler models than a more robust generative AI model, further reducing the computing resources that would be required if a single generative AI model was tasked with performing the actionability check, generating feedback, and/or processing the various input prompts.

After determining actionability of the feedback data (and associated prompt), the actionability model(s) 124b may perform an act 212 of providing the actionability status to the generative AI application 108. The feedback tool(s) 112 of the generative AI application 108 may then perform an act 214 of conveying the actionability status 214 to the prompt interface 110 of the generative AI application 108. In one or more embodiments, the actionability model(s) 124b may simply provide the actionability status to the generative AI model and/or the feedback model(s) 124a.

It will be appreciated that subsequent steps shown in FIG. 2 may be performed in the event that the actionability status indicates that the feedback data provided to the actionability model(s) 124b is either (1) actionable or (2) maybe actionable. In the scenario where the actionability model(s) 124b determines that the feedback data is not actionable, the process may terminate and no further steps to modify or otherwise improve the initial prompt would be performed.

As shown in FIG. 2, the generative AI application 108 may perform an act 216 of providing the feedback data and prompt to the feedback model(s) 124a for further processing. At this stage, the feedback model(s) 124a may perform any of a number of different acts relate to collecting additional feedback. Acts 218-224 describe a couple of example acts that may be performed. While FIG. 2 illustrates an example in which each of the acts 218-224 are performed, it will be appreciated that in one or more embodiments, some or a portion of these acts 218-224 may be performed without performing each of the acts related to collecting additional feedback data.

As an example, and as shown in FIG. 2, the feedback model 124a may perform an act 218 of determining feedback icon(s). In one or more embodiments, this may involve determining one or more items of information that, if included within a modified prompt, would result in an improved prompt over the initial prompt that yielded the unsatisfactory output. In one or more embodiments, this involves determining one or more items of information that would make an updated prompt actionable if included or otherwise incorporated within the modified prompt.

As shown in FIG. 2, the feedback model 124a may perform an act 220 of providing the feedback icon(s) to the generative AI application 108 for presenting to the client. In one or more embodiments, this involves presenting selectable elements (e.g., selectable icons) via a GUI of a client device that may be selected by a user of the client device. In one or more embodiments, this includes providing selectable items including the indicated items of information, and may include a variety of items of information indicated therein. Examples of these feedback icons will be discussed below in connection with various examples.

In one or more embodiments, the feedback icons refer to selectable elements that, when selected, indicate one or more items of information for the feedback model 124a to consider in facilitating a modified prompt. As shown in FIG. 2, the feedback model 124 may perform an act 222 of receiving user interactions associated with providing additional feedback. In one or more embodiments, this involves receiving or otherwise detecting a selection of a graphical icon indicating the additional item(s) of information to incorporate within a modified prompt. In one or more embodiments, this involves receiving content composed by a user (e.g., text entered by a user in a text window) indicating one or more items of information to incorporate within an updated prompt. Examples illustrating various ways in which this user interaction data may be received will be discussed in further detail below.

Based on the received user interactions, the feedback model 124a may perform an act 224 of providing additional information to the generative AI application 108. Once received, the generative AI application 108 may perform an act 226 of detecting a user selection of the additional item(s) to be included within a prompt. In one or more embodiments, this may involve composing a new guided prompt based on feedback information presented to a user. In one or more embodiments, this may involve detecting a selection of a new prompt or one or more specific items of information to include within a modified prompt.

Once the feedback data is collected, and a user selection in connection with the feedback data is received, the generative AI application 108 may perform an act 228 of updating the initial prompt. In one or more embodiments, the updated prompt includes a combination of the initial prompt and one or more additional items of information drawn from the feedback data. In one or more embodiments, the generative AI model is applied to the updated/modified prompt and a new output is generated based on the modified prompt that will be presumably more satisfactory than the output from the initial prompt.

In one or more embodiments, this process may be repeated with respect to the new output. For example, while a user of the generative AI application 108 may ultimately indicate that the new output is satisfactory, in one or more embodiments, the user can (again) select an icon or otherwise provide feedback indicating that the new output is unsatisfactory. In response, the systems described herein may repeat the process shown in FIG. 2 with respect to the new output to determine additional feedback and identify any further items of information that may be included within a new updated prompt to further improve the output of the generative AI model.

FIGS. 3A-3C illustrate an example implementation of the AI model feedback system 114 in collecting feedback and presenting feedback icons in accordance with one or more embodiments. In particular, FIG. 3A illustrates an example client device 302 having a graphical user interface (GUI) 304 (or simply GUI 304) on which the client device 302 may present the various features generated and presented by the AI model feedback system 114.

In this example, a user may generate an initial prompt 306. As shown in FIG. 3A, the initial prompt 306 may refer to a text prompt including a text string that reads “Summarize marketing presentation.” In response, a generative AI model may be applied to the initial prompt 306 to generate a first output 308. As shown in FIG. 3A, the first output 308 may include a text string that reads “Sure! Here is a summary:” followed by a summary that the generative AI model generates based on the initial prompt 306. In this example, a user of the client device may provide feedback through use of a feedback tool 310. In this example, the feedback tool 310 includes an up arrow to indicate positive or satisfaction with the first output 308 and a down arrow to indicate negative or lack of satisfaction with the first output 308.

Consistent with one or more embodiments described above, a user may interact with the feedback tool 310 indicate whether the first output 308 is a satisfactory response to the initial prompt 306. In this example, a user may select the down arrow to indicate that the first response 308 is unsatisfactory. In response to this selection, the client device (e.g., the generative AI application on the client device) may provide a window including a feedback request.

This feedback request window or interface is shown in FIG. 3B. In one or more embodiments, this interface is presented over the interface of the generative AI model to provide a space within which a user of the client device 302 can enter additional feedback data indicating a reason why the first output 308 was unsatisfactory. In this example, a user may enter feedback data 312 including a text string that reads: “I wanted a summary of the June presentation.”

In accordance with one or more embodiments described above, this feedback data 312 may be provided (e.g., in combination with the initial prompt 306) to an actionability model for use in determining actionability of a modified prompt based on the feedback data 312. Consistent with examples discussed above, the actionability model may determine whether the feedback data 312 is actionable by the generative AI model if incorporated within a modified prompt. If actionable (or maybe actionable), the actionability model causes the feedback data and prompt (and actionability status) to be provided to a feedback model. In accordance with one or more embodiments, the feedback model may be applied to the feedback data and the initial prompt to generate one or more feedback icons.

As shown in FIG. 3C, the feedback model may generate and cause multiple feedback icons 314, 316 to be presented via the GUI 304 of the client device 302. In this example, a first feedback icon 314 is presented including a text string that reads “Do you want a summary of the June 15 presentation? ”. A second feedback icon 316 is also presented including a text string that reads “Can you provide the document of the presentation? ”. In one or more embodiments, the feedback icons (e.g., icons 314-316) may be reworded as a revised prompt that a user may click and cause to send back to the AI model feedback system 114 (e.g., rather than the prompt being directed at a user). Thus, the feedback icon could read “Summarize the June 15 market presentation” or “Summarize [/filename]” with the specific file being attached as part of the prompt.

Each of these feedback icons may be determined and generated based on a combination of the initial prompt and the feedback data provided by the user. For example, a feedback model may be applied to a combination of the feedback data (e.g., a verbatim) and the initial prompt (e.g., the prompt content) and determined based on an analysis of this plain language text that the modified prompt asking for a more specific summary of the June 15 presentation would be a more effective prompt than the initial prompt. The feedback model may additionally (or alternatively) determine that the generative AI model does not necessarily have access to a document of the presentation, and that obtaining access to the document of the presentation to include in connection with the modified prompt would likely result in a much more satisfactory or otherwise response output than the first output presented in FIG. 3A.

In this example, the specific feedback icons 314, 316 may be presented without requiring that a user of the client device 302 necessarily provide additional feedback above and beyond the feedback data 312 provided in FIG. 3B. In this example, this determination to generate the feedback icons 314, 316 without additional user input may be based on a determination by the actionability model that the feedback data 312 provided by the user is indeed actionable with or without additional feedback information. Thus, rather than generating hints or additional questions to guide the user in providing additional data (e.g., as discussed in other examples, and as will be discussed in further detail below), the feedback model may simply provide the plurality of feedback icons 314, 316 with reasonable confidence that a selection of one of the feedback icons 314, 316 will provide sufficient information to generate an effective modified prompt.

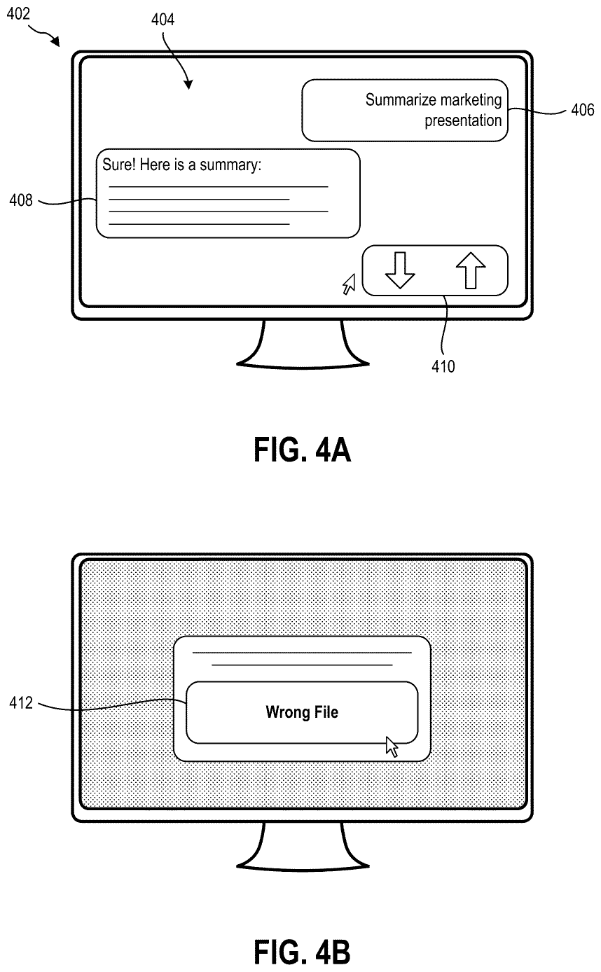

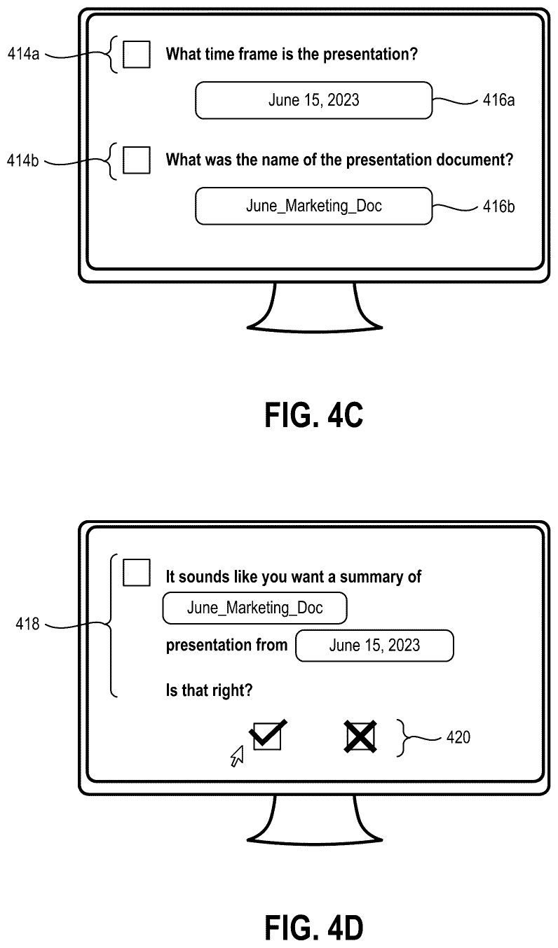

FIGS. 4A-4D illustrate another example series of GUIs showing additional features and functionality of an AI model feedback system 114 in accordance with one or more embodiments described herein. In particular, FIG. 4A illustrates an example client device 402 having a GUI 404 on which the client device 402 may present various features generated and presented by the AI model feedback system 114. Similar to the example discussed above in connection with FIG. 3A, a user may enter an initial prompt 406 and receive a first output 408 including similar text and content as the example shown in FIG. 3A. In addition, a user of the client device 402 may similarly interact with a feedback tool 410 to indicate whether the first output 408 is satisfactory or not. In this example, a user selects an icon indicating that the first output 408 is unsatisfactory.

FIG. 4B an example feedback request window similar to the window discussed above in connection with FIG. 3B. In this example, rather than giving a more helpful feedback response, a user types feedback data 412 including a shorter and less informative response with text that reads “Wrong File.”

Similar to other examples, the feedback data 412 is provided (e.g., in combination with the initial prompt 406) to an actionability model to be used in determining actionability of a modified prompt based on the feedback data 412. While the example discussed in connection with FIG. 3B was determined by an actionability model to be actionable, the same actionability model may instead determine that this feedback data 412 is either not actionable or is “maybe” actionable. For the sake of explanation, in this example, the actionability model determines the “wrong file” verbatim to be maybe actionable, which means that the actionability model determines that the feedback data 412 could be actionable if additional data is collected that, if incorporated into a modified prompt, would yield a more helpful output than the first output 408 of FIG. 4A.

In one or more embodiments, where the actionability model comes to a determination of “maybe” actionable, the actionability model works with the feedback model to provide one or more feedback hints to a user of the client device 402 to collect or otherwise obtain additional feedback data. In this example, as shown in FIG. 4C, the feedback model provides a first hint 414a including a question that reads “What time frame is the presentation? ”. In response, the user may provide a first hint response 416a including text that reads “Jun. 15, 2023.” In one or more embodiments, the hint response could be more vague or indefinite, such as indicating a particular month, year, or range of time within which the presentation was given or otherwise presented.

As further shown in FIG. 4C, the feedback model provides a second hint 414b including a question that reads “What was the name of the presentation document? ” In response, the user of the client device 402 may provide a second hint response 416b including text that reads “June_Marketing_Doc” indicating a file name of the relevant presentation. Other implementations may involve providing a less definite answer, such as one or more key words within a body of the document, other keywords that might be similar to the name of the document, or other relevant data that the model(s) can use in attempting to identify the relevant document.

In one or more embodiments, the feedback hints are determined and provided based on knowledge of the infrastructure of a generative AI model. For example, the respective additional models (e.g., the feedback model and/or actionability model) may have internal knowledge as to the types of inputs that would be particularly helpful for a generative AI model to receive as input in generating a more responsive output for a user. In this example, the feedback model and/or actionability model has access to model data and parameters that inform the specific hints that are provided in an effort to identify a document as well as a time range or date associated with the document for use in generating a modified prompt that will guide the generative AI model into preparing a highly responsive output to a prompt from the user given the additional feedback data.

In this example, the answers to the feedback hints 414a-b may be again provided to the actionability model to again determine whether a combination of the initial prompt and the initial feedback (e.g., the “Wrong File” feedback), as well as the additional feedback data (e.g., the hint responses 416a-b) would be actionable by the generative AI model. In the event that it would not be actionable, the process may terminate. However, in the event that the actionability model determines that this additional feedback data renders the initially provided feedback and the initial prompt as actionable (e.g., predicted to be actionable), the actionability model and/or feedback model may proceed forward with generating and providing a feedback icon(s) to the user via the GUI 404 of the client device 402.

For example, as shown in FIG. 4D, the feedback model may provide a feedback icon 418 based on the answers to the feedback hints 414a-b rendering the feedback data and the initial prompt as actionable. In this example, the feedback model provides a feedback icon 418 including text that reads “It sounds like you want a summary of June_Marketing_Doc presentation from Jun. 15, 2023. Is that right? ” A user may interact with the feedback icon in a number of ways to confirm the feedback. In this example, the user may interact with the feedback icon by selecting a confirmation input 420 indicating that the feedback question is correct and that the generative AI model is good to use this feedback data in generating a modified prompt.

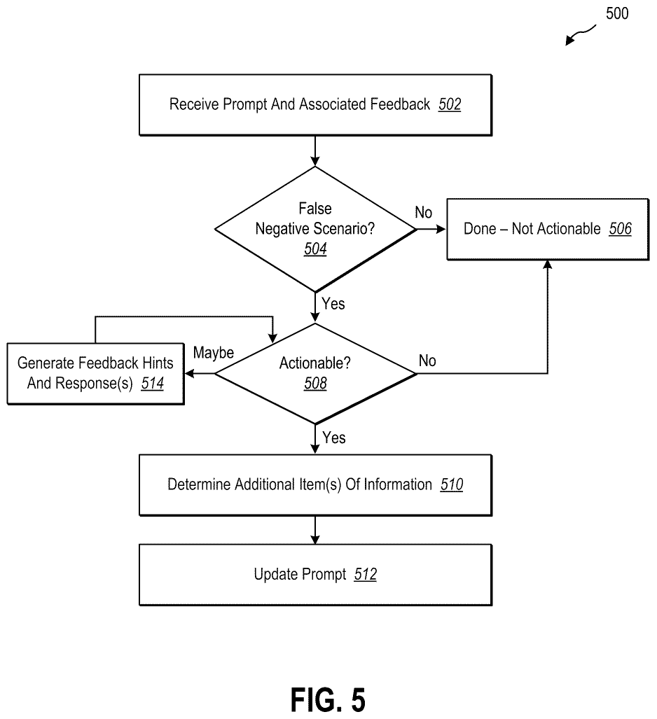

Additional detail will now be discussed in connection with determining actionability of a given set of feedback data. For example, FIG. 5 illustrates an example series of acts 500 that may be performed in one or more embodiments (e.g., by an actionability model, such as an actionability LLM) to determine whether feedback data is actionable, not actionable, or whether additional feedback data is needed to make a resulting prompt actionable.

As shown in FIG. 5, the series of acts 500 includes an act 502 of receiving a prompt and associated feedback. This may be performed in a similar manner as the examples discussed above when a user determines that an output is unsatisfactory and provides an indication that the output is non-responsive, inaccurate, or otherwise unhelpful in responding to an initial prompt. In one or more embodiments, this additionally includes providing a feedback request and receiving a response to the feedback request indicating one or more reasons (e.g., composed or selected by a user) as to why the output was unsatisfactory.

As shown in FIG. 5, the series of acts 500 further includes an act 504 of determining whether a false negative scenario applies. In one or more embodiments, this involves determining whether one of a plurality of known or predetermined false negative scenarios applies to the feedback data and corresponding prompt. Examples of these scenarios include the generative AI model not having access to existing content, the generative AI model relying on incorrect sources, the generative AI model generating the output based on outdated data, the output of the generative AI model including incorrect data, the output of the generative AI model missing data, and/or a failure by the generative AI model to generate content. These are intended to be unlimiting examples and additional examples may be considered in determining whether the false negative scenario applies.

In the event that none of the known false negative scenarios apply, the series of acts 500 includes an act 506 of designating the process as done or otherwise not actionable. Alternatively, in the event one of the known false negative scenarios does apply, the series of acts 500 proceeds in performing an act 508 in which the actionability model determines whether the feedback data is actionable. As shown in FIG. 5, it will be appreciated that the act 504 of determining the false negative scenario may be performed prior to determining actionability. This can eliminate many scenarios where the actionability model or other generative AI model is not necessary to determine whether an updated prompt needs to be generated (e.g., because it simply cannot be generated under a non-applicable set of circumstances, such as when the feedback is completely irrelevant to the prompt and/or outside of the capability of the generative AI model).

As shown in FIG. 5, the act 508 of determining whether the feedback data is actionable may involve determining that the feedback data is actionable (e.g., the yes branch of act 508). In this scenario, the series of acts 500 may proceed to performing an act 510 of determining additional item(s) of information. This act 510 may involve determining one or more feedback icons to present to solicit one or more additional items of information based on the feedback data and the initial prompt. For example, a feedback model may provide a selectable icon (e.g., such as those shown in FIG. 3C) that a user may select to identify the one or more additional items of information to incorporate within an updated prompt.

Once the additional item(s) of information are determined, the series of acts 500 may proceed with performing an act 512 of updating the prompt (e.g., the generative AI model may generate a modified or otherwise updated prompt). In accordance with one or more embodiments described herein, this may involve generating a modified prompt based on a combination of content from the initial prompt, the response to a feedback request, and a user selection in connection with the feedback icon(s) that are presented to a user.

Going back to act 508, where an actionability model determines that feedback data (e.g., the response to the feedback request) is “maybe” actionable, the feedback model may perform an act 514 of generating feedback hints and gathering responses. This may be performed and presented in a similar manner as discussed above in connection with FIG. 4C in which hints or questions are provided to a user to guide the user in providing relevant items of information that would potentially cause an updated prompt generated from the additional feedback data to be actionable.

After generating the additional feedback data, the actionability model may again perform the act 508 of determining actionability. This act of determining actionability may be based on a combination of the initial prompt, the response to the initial request for feedback data, as well as the answers or responses to the feedback hint(s) that are provided by the feedback model. Where the actionability model determines actionability at this stage, the series of acts 500 proceeds and acts 510 and 512 may be performed. In the event that the actionability model determines that the additional feedback data is insufficient, the series of acts may proceed in performing act 506 and terminating the feedback and update process.

It will be appreciated that this loop of determining that feedback data and additional feedback data can be performed any number of times. Nevertheless, in one or more embodiments, this loop may be performed a single iteration such that once a determination of “maybe” actionable has been determined, the next iteration must be a determination of “yes” or “no.” This determination may be based on a threshold level of confidence of the actionability model that a resulting modified prompt would be actionable by a generative AI model.

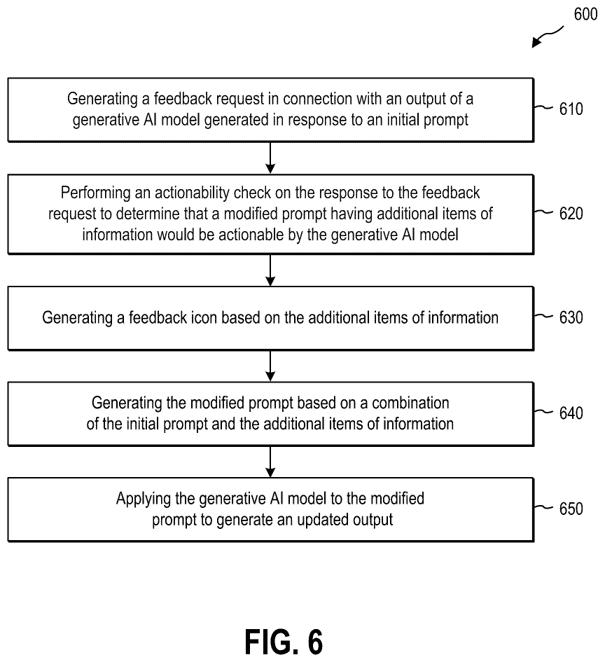

Turning now to FIG. 6, this figure illustrates an example flow chart including a series of acts for collecting feedback associated with an output of a generative AI model and generating a revised prompt for the generative AI model based on feedback data provided and generated based on potential actionability of the feedback data. While FIG. 6 illustrates acts according to one or more embodiments, alternative embodiments may omit, add to reorder, and/or modify any of the acts shown in FIG. 6. The acts of FIG. 6 may be performed as part of a method. Alternatively, a non-transitory computer-readable medium can include instructions thereon that, when executed by one or more processors, cause a server device and/or client device to perform the acts of FIG. 6. In still further embodiments, a system can perform the acts of FIG. 6.

As noted above, FIG. 6 illustrates a series of acts 600 related to updating an AI model prompt based on feedback generated in response to unsatisfactory output responsive to the AI model prompt. As shown in FIG. 6, the series of acts 600 includes an act 610 of generating a feedback request in connection with an output of a generative AI model generated in response to an initial prompt. In one or more embodiments, the act 610 includes providing a feedback request in connection with an output of a generative AI model, the output being generated in response to an initial prompt provided as input to the generative AI model. In one or more embodiments, the response to the feedback request includes an indication that the output of the generative AI model is a non-satisfactory response to the initial prompt.

As further shown, the series of acts 600 includes an act 620 of performing an actionability check on the response to the feedback request to determine that a modified prompt having additional item(s) of information would be actionable by the generative AI model. In one or more embodiments, the act 620 includes performing, in response to receiving a response to the feedback request, an actionability check on the response to the feedback request to determine that a modified prompt having one or more additional items of information based on the response to the feedback request would be actionable by the generative AI model.

As further shown, the series of acts 600 includes an act 630 of generating a feedback icon based on the additional items of information. In one or more embodiments, the act 630 includes generating a feedback icon based on the one or more additional items of information, the feedback icon including an interactive element associated with indicating the one or more additional items of information.

As further shown, the series of acts 600 includes an act 640 of generating the modified prompt based on a combination of the initial prompt and the additional items of information. In one or more embodiments, the act 640 includes generating, based on a user interaction with the interactive element, the modified prompt, wherein content of the modified prompt is based on a combination of the initial prompt and the one or more additional items of information.

As further shown, the series of acts 600 includes an act 650 of applying the generative AI model to the modified prompt to generate an updated output. In one or more embodiments, the act 650 includes applying the generative AI model to the modified prompt to generate an updated output of the generative AI model.

In one or more embodiments, performing the actionability check includes generating a feedback prompt as an input to a feedback model in communication with the generative AI model, the feedback model being configured to determine whether the initial prompt, if updated to include the one or more additional items of information, would provide an improved output relative to the output generated by the generative AI model in response to the initial prompt. In one or more embodiments, the feedback model is a second generative AI model. In one or more embodiments, performing the actionability check includes determining that a combination of the initial prompt and the feedback response includes the one or more additional items of information that, if incorporated into the modified prompt, would provide the improved output relative to the output generated by the generative AI model in response to the initial prompt.

In one or more embodiments, performing the actionability check includes determining that the combination of the initial prompt and the feedback response might include the one or more additional items of information given additional user feedback. In one or more embodiments, performing the actionability check includes generating one or more feedback hints associated with gathering the additional user feedback. In one or more embodiments, performing the actionability check includes determining that the combination of the initial prompt, the feedback response, and at least one response to the one or more feedback hints includes the one or more additional items of information that, if incorporated into the modified prompt, would provide an improved output relative to the output generated by the generative AI model in response to the initial prompt.

In one or more embodiments, the interactive element includes one or more selectable icons presented via a graphical user interface (GUI) of a client device, the selectable icons indicating the one or more additional items of information where the user interaction with the interactive element includes a selection of the one or more selectable icons. In one or more embodiments, the interactive element includes a feedback hint presented via a graphical user interface (GUI), the feedback hint including a text box within which a user can enter a response to the feedback hint. The user interaction may include the response to the feedback hint including content entered within the text box presented via the GUI.

In one or more embodiments, the generative AI model is a large language model (LLM). In one or more embodiments, the actionability check is performed by a second LLM. In one or more embodiments, generating the feedback icon is performed by a third LLM. In one or more embodiments, the initial prompt and the modified prompt are provided as inputs to the generative AI model as part of a same session.

In one or more embodiments, performing the actionability check includes determining that the response to the feedback request indicates at least one of a plurality of predefined false negative scenarios. The false negative scenarios may include one or more of the generative AI model not having access to existing content, the generative AI model relying on incorrect sources, the generative AI model generating the output based on outdated data, the output of the generative AI model including incorrect data, the output of the generative AI model missing data, and/or a failure by the generative AI model to generate content.

FIG. 7 illustrates certain components that may be included within a computer system 700. One or more computer systems 700 may be used to implement the various devices, components, and systems described herein.

The computer system 700 includes a processor 701. The processor 701 may be a general-purpose single-or multi-chip microprocessor (e.g., an Advanced RISC (Reduced Instruction Set Computer) Machine (ARM)), a special purpose microprocessor (e.g., a digital signal processor (DSP)), a microcontroller, a programmable gate array, etc. The processor 701 may be referred to as a central processing unit (CPU). Although just a single processor 701 is shown in the computer system 700 of FIG. 7, in an alternative configuration, a combination of processors (e.g., an ARM and DSP) could be used.

The computer system 700 also includes memory 703 in electronic communication with the processor 701. The memory 703 may be any electronic component capable of storing electronic information. For example, the memory 703 may be embodied as random access memory (RAM), read-only memory (ROM), magnetic disk storage media, optical storage media, flash memory devices in RAM, on-board memory included with the processor, erasable programmable read-only memory (EPROM), electrically erasable programmable read-only memory (EEPROM) memory, registers, and so forth, including combinations thereof.

Instructions 705 and data 707 may be stored in the memory 703. The instructions 705 may be executable by the processor 701 to implement some or all of the functionality disclosed herein. Executing the instructions 705 may involve the use of the data 707 that is stored in the memory 703. Any of the various examples of modules and components described herein may be implemented, partially or wholly, as instructions 705 stored in memory 703 and executed by the processor 701. Any of the various examples of data described herein may be among the data 707 that is stored in memory 703 and used during execution of the instructions 705 by the processor 701.

A computer system 700 may also include one or more communication interfaces 709 for communicating with other electronic devices. The communication interface(s) 709 may be based on wired communication technology, wireless communication technology, or both. Some examples of communication interfaces 709 include a Universal Serial Bus (USB), an Ethernet adapter, a wireless adapter that operates in accordance with an Institute of Electrical and Electronics Engineers (IEEE) 802.11 wireless communication protocol, a Bluetooth® wireless communication adapter, and an infrared (IR) communication port.

A computer system 700 may also include one or more input devices 711 and one or more output devices 713. Some examples of input devices 711 include a keyboard, mouse, microphone, remote control device, button, joystick, trackball, touchpad, and lightpen. Some examples of output devices 713 include a speaker and a printer. One specific type of output device that is typically included in a computer system 700 is a display device 715. Display devices 715 used with embodiments disclosed herein may utilize any suitable image projection technology, such as liquid crystal display (LCD), light-emitting diode (LED), gas plasma, electroluminescence, or the like. A display controller 717 may also be provided, for converting data 707 stored in the memory 703 into text, graphics, and/or moving images (as appropriate) shown on the display device 715.

The various components of the computer system 700 may be coupled together by one or more buses, which may include a power bus, a control signal bus, a status signal bus, a data bus, etc. For the sake of clarity, the various buses are illustrated in FIG. 7 as a bus system 719.

The techniques described herein may be implemented in hardware, software, firmware, or any combination thereof, unless specifically described as being implemented in a specific manner. Any features described as modules, components, or the like may also be implemented together in an integrated logic device or separately as discrete but interoperable logic devices. If implemented in software, the techniques may be realized at least in part by a non-transitory processor-readable storage medium comprising instructions that, when executed by at least one processor, perform one or more of the methods described herein. The instructions may be organized into routines, programs, objects, components, data structures, etc., which may perform particular tasks and/or implement particular data types, and which may be combined or distributed as desired in various embodiments.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

As used herein, non-transitory computer-readable storage media (devices) may include RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

The steps and/or actions of the methods described herein may be interchanged with one another without departing from the scope of the claims. In other words, unless a specific order of steps or actions is required for proper operation of the method that is being described, the order and/or use of specific steps and/or actions may be modified without departing from the scope of the claims.

The term “determining” encompasses a wide variety of actions and, therefore, “determining” can include calculating, computing, processing, deriving, investigating, looking up (e.g., looking up in a table, a database, or another data structure), ascertaining and the like. Also, “determining” can include receiving (e.g., receiving information), accessing (e.g., accessing data in a memory) and the like. Also, “determining” can include resolving, selecting, choosing, establishing and the like.

The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. For example, any element or feature described in relation to an embodiment herein may be combinable with any element or feature of any other embodiment described herein, where compatible.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A method for updating an artificial intelligence (AI) model prompt based on feedback generated in response to unsatisfactory output responsive to the AI model prompt, the method comprising:
providing a feedback request in connection with an output of a generative AI model, the output being generated in response to an initial prompt provided as input to the generative AI model;
performing, in response to receiving a response to the feedback request, an actionability check on the response to the feedback request to determine that a modified prompt having one or more additional items of information based on the response to the feedback request would be actionable by the generative AI model;
generating a feedback icon based on the one or more additional items of information, the feedback icon including an interactive element associated with indicating the one or more additional items of information;
generating, based on a user interaction with the interactive element, the modified prompt, wherein content of the modified prompt is based on a combination of the initial prompt and the one or more additional items of information; and
applying the generative AI model to the modified prompt to generate an updated output of the generative AI model.

2. The method of claim 1, wherein the response to the feedback request includes an indication that the output of the generative AI model is a non-satisfactory response to the initial prompt.

3. The method of claim 1, wherein performing the actionability check includes generating a feedback prompt as an input to a feedback model in communication with the generative AI model, the feedback model being configured to determine whether the initial prompt, if updated to include the one or more additional items of information, would provide an improved output relative to the output generated by the generative AI model in response to the initial prompt.

4. The method of claim 3, wherein the feedback model is a second generative AI model.

5. The method of claim 3, wherein performing the actionability check includes determining that a combination of the initial prompt and the feedback response includes the one or more additional items of information that, if incorporated into the modified prompt, would provide the improved output relative to the output generated by the generative AI model in response to the initial prompt.

6. The method of claim 3, wherein performing the actionability check includes determining that the combination of the initial prompt and the feedback response might include the one or more additional items of information given additional user feedback.

7. The method of claim 6, wherein performing the actionability check includes generating one or more feedback hints associated with gathering the additional user feedback.

8. The method of claim 7, wherein performing the actionability check includes determining that the combination of the initial prompt, the feedback response, and at least one response to the one or more feedback hints includes the one or more additional items of information that, if incorporated into the modified prompt, would provide an improved output relative to the output generated by the generative AI model in response to the initial prompt.

9. The method of claim 1, wherein the interactive element includes one or more selectable icons presented via a graphical user interface (GUI) of a client device, the selectable icons indicating the one or more additional items of information, wherein the user interaction with the interactive element comprises a selection of the one or more selectable icons.

10. The method of claim 1, wherein the interactive element includes a feedback hint presented via a graphical user interface (GUI), the feedback hint comprising a text box within which a user can enter a response to the feedback hint, wherein the user interaction comprises the response to the feedback hint including content entered within the text box presented via the GUI.

11. The method of claim 1, wherein the generative AI model is a large language model (LLM).

12. The method of claim 11, wherein the actionability check is performed by a second LLM, and wherein generating the feedback icon is performed by a third LLM.

13. The method of claim 1, wherein performing the actionability check includes determining that the response to the feedback request indicates at least one of a plurality of predefined false negative scenarios, the plurality of predefined false negative scenarios including one or more of:
the generative AI model not having access to existing content;
the generative AI model relying on incorrect sources;
the generative AI model generating the output based on outdated data;
the output of the generative AI model including incorrect data;
the output of the generative AI model missing data; and
a failure by the generative AI model to generate content.

14. The method of claim 1, wherein the initial prompt and the modified prompt are provided as inputs to the generative AI model as part of a same session.

15. A system for updating an artificial intelligence (AI) model prompt based on feedback generated in response to unsatisfactory output responsive to the AI model prompt, the system comprising:
at least one processor;
memory in electronic communication with the at least one processor; and
instructions stored in the memory, the instructions being executable by the at least one processor to:
provide a feedback request in connection with an output of a generative AI model, the output being generated in response to an initial prompt provided as input to the generative AI model;
perform, in response to receiving a response to the feedback request, an actionability check on the response to the feedback request to determine that a modified prompt having one or more additional items of information based on the response to the feedback request would be actionable by the generative AI model;
generate a feedback icon based on the one or more additional items of information, the feedback icon including an interactive element associated with indicating the one or more additional items of information;
generate, based on a user interaction with the interactive element, the modified prompt, wherein content of the modified prompt is based on a combination of the initial prompt and the one or more additional items of information; and
apply the generative AI model to the modified prompt to generate an updated output of the generative AI model.

16. The system of claim 15, wherein performing the actionability check includes generating a feedback prompt as an input to a feedback model in communication with the generative AI model, the feedback model being configured to determine whether the initial prompt, if updated to include the one or more additional items of information, would provide an improved output relative to the output generated by the generative AI model in response to the initial prompt.

17. The system of claim 16, wherein performing the actionability check includes determining that a combination of the initial prompt and the feedback response includes the one or more additional items of information that, if incorporated into the modified prompt, would provide the improved output relative to the output generated by the generative AI model in response to the initial prompt.

18. The system of claim 16,
wherein performing the actionability check includes determining that the combination of the initial prompt and the feedback response might include the one or more additional items of information given additional user feedback,
wherein performing the actionability check includes generating one or more feedback hints associated with gathering the additional user feedback, and
wherein performing the actionability check includes determining that the combination of the initial prompt, the feedback response, and at least one response to the one or more feedback hints includes the one or more additional items of information that, if incorporated into the modified prompt, would provide an improved output relative to the output generated by the generative AI model in response to the initial prompt.

19. A non-transitory computer readable medium storing instructions thereon that, when executed by at least one processor, causes a computing device to:
provide a feedback request in connection with an output of a generative AI model, the output being generated in response to an initial prompt provided as input to the generative AI model;
perform, in response to receiving a response to the feedback request, an actionability check on the response to the feedback request to determine that a modified prompt having one or more additional items of information based on the response to the feedback request would be actionable by the generative AI model;
generate a feedback icon based on the one or more additional items of information, the feedback icon including an interactive element associated with indicating the one or more additional items of information;
generate, based on a user interaction with the interactive element, the modified prompt, wherein content of the modified prompt is based on a combination of the initial prompt and the one or more additional items of information; and
apply the generative AI model to the modified prompt to generate an updated output of the generative AI model.

20. The non-transitory computer readable medium of claim 19, wherein performing the actionability check includes generating a feedback prompt as an input to a feedback model in communication with the generative AI model, the feedback model being configured to determine whether the initial prompt, if updated to include the one or more additional items of information, would provide an improved output relative to the output generated by the generative AI model in response to the initial prompt.
